(19) United States
(12) Patent Application Publication
(10) Pub. No.: US 2011/0162356 A1
(43) Pub. Date: Jul. 7, 2011

(54) Rotational gravity/buoyancy power generator

(76) Inventor: Douglas Reynolds Hastings, (US)

(21) Appl. No.: 12/803,229

(22) Filed: Jun. 22, 2010

Related U.S. Application Data
(60) Provisional application No. 61/269,747, filed on Jun. 29, 2009.

(51) Int. Cl. F03B 17/02

(52) U.S. Cl. 60/495

(57) ABSTRACT

The rotational gravity/buoyancy power generator relates to the generation of power by harnessing the gravitational and buoyant forces which act on an apparatus in a natural or man-made liquid medium and converting such forces into mechanical energy. More specifically, the rotational gravity/buoyancy power generator improves on operably different, fluid medium power generators by efficiently utilizing the gravitational force as efficiently as the buoyant force is harnessed. The rotational gravity/buoyancy power generator includes methods, systems and devices for a plurality of weighted containers with a movable closure means on one or both ends, attached to one or more chains, belts or conveyances with one or more rotating sprockets or pulleys on horizontally aligned shafts which form a continuous loop in primarily a vertical arrangement comprising ascending and descending phases upon such apparatus in a continuous and flowing movement (FIG. 1). In the descent phase the containers are open on both ends (FIG. 2) and have greater density than the volume of liquid they displace causing them to rapidly sink through the liquid medium due to the force of gravity. In the ascent phase the containers have either their upper ends sealed, both ends sealed or are filled by internal bladders when, in any embodiment, a volume of gas is introduced such that the overall volume of the containers have a lesser density than the liquid displaced causing the containers to rise through the liquid medium due to the buoyant force. The chains, belts or conveyances to which the containers are attached rotate the sprockets or pulleys and their associated shafts creating mechanical power. Such power can be used to turn electrical generators or other mechanical machines which necessitate such power input.

### CROSS REFERENCE TO RELATED APPLICATIONS

This application claims the benefit of Provisional Patent Application Ser. No. 61/269,747, filed Jun. 29, 2009 by the present inventor

### FEDERALLY SPONSORED RESEARCH

none

### SEQUENCE LISTING

none

Primary Class: 60/495; 60/496; 415/5

renewable and do not deplete resources or pollute the environment. Further, in the United States and many net oil importing countries, there is a need to develop and harness local energy resources to reduce dependence on foreign sources of energy, namely oil.

As a consequence, alternative energy exploration and development proceeds apace to harness energy produced by wind, solar, bioenergy, geothermal, and wave/tidal to name the most scrutinized. Providing a reasonable, steady, continuous and sufficient energy from these sources mostly focuses on their use for generating electricity. However, there are issues with each of these alternative energy sources not the least of which is scalability, efficiency, cost, aesthetics, weather, location and day to day variances in local environments.

Present alternative energy solutions include: proposed large scale wind farms which cost billions of dollars utilizing thousands of acres and stand still on windless days; huge solar panel arrays, whether for electricity or heat that remain ineffective on cloudy or cool days; bioenergy, with ethanol as an example, does not truly result in a net carbon return and is considered a contributor to driving up global food costs, and geothermal installations which can take years to test and develop with no guarantee of successful energy production.

The concept of energy production from water sources and/or buoyancy dates back to the earliest waterwheels and further back to Archimedes exclaiming “Eureka” when finding a method to define principles of buoyancy. However, as will be shown in the Description of Prior Art, not until now has energy production from gravity and buoyancy, acting through an appropriate apparatus, been effectively rendered viable.

Gravity and buoyancy are the essential scientific principles at stake in the rotational gravity/buoyancy power generator. A body in a liquid medium which has a greater density than the liquid it displaces will sink in that medium. Conversely one with a lesser density will rise. For the sake of example, a gallon of common fresh water at a normal temperature, at sea level, has a mass of 8.34 pounds and a volume of 231 cubic inches. Therefore, combining these two concepts, an object which has a mass of say 10 pounds, with a volume of 231 cubic inches will sink in the referenced liquid medium as it is denser than the liquid is displaces and the force of gravity “pulls” it downward. An object which occupies 231 cubic inches with a mass of say 7 pounds will rise in the liquid medium as it is less dense than the liquid it displaces and the buoyant force will “push” it through the liquid medium. Therefore it is not the “weight” of the buckets or pods or containers which must change to be acted on by gravity or buoyancy but their density which must become greater and lesser in the sinking and rising phases.

The rotational gravity/buoyancy power generator utilizes both of these principles by configuring weighted containers which have the purposely designed capacity to have a much greater density than the liquid they displace on the downward, sinking, or gravity phase and a much lower density than the liquid they displace on the upward, rising or buoyant phase. Of particular note, the rotational gravity/buoyancy power generator efficiently utilizes containers which are purposely designed to have a greater density than the liquid they displace and pass through the liquid medium—as the liquid medium passes through them—with minimal friction. As a result, the plurality of the containers, in total, produces a significant amount of power during their descent phase.

The rotational gravity/buoyancy power generator does not require the sun, wind, monopolize massive tracts of land or sea, or redirect scarce food resources. It can operate in almost any environment, can be located directly in the path of existing power grids, can generate distributed electricity for localized consumption, is not offensive to the eye or local environment and can operate around the clock, day and night without fluctuating output or unreliable operation as is the case with both wind and solar power.

### DESCRIPTION OF PRIOR ART

U.S. Pat. No. 2,135,110 to Platt exemplifies many commonalities found in buoyancy styled energy generators. A series of buckets are mounted to an endless vertically aligned chain which rotates around sprockets which, in turn, rotate shafts. The buckets are pointed, closed on one end and open on the other. They face point down on the descent and are filled with water which rushes into the upper, open end. On their ascent the buckets are filled with air which causes them to rise. The problem in Platt and others is best illustrated by the statement “The buckets thus are lighter during their upward movement than during their downward movement filled with water, and this causes the chain to move and turn the wheels on which it is mounted.” In fact, the “buckets” in Platt or any other configuration are not lighter or heavier at any time during their ascent or descent (providing they do no leave the liquid medium as some configurations show). The mass or weight of the buckets is constant. The only property which changes in Platt is the volume of space which the bucket and its injected gas occupy in the ascent. As a result they may have a lesser overall density than the liquid displaced and be “pushed” upward due to the buoyant force.

U.S. Pat. No. 212,186 to Burwell, in some ways similar to Platt, also attempts to utilize the weight of water as adding to the downward motion of the buckets. The problem here is that one gallon of water displaces one gallon of water. The net affect, when looking at water as a “weight” alone is that it has a neutral density when immersed in a like liquid.

U.S. Pat. No. 3,934,964 to Diamond shows a plurality of piston-filled cylinders, in hose linked pairs, mounted on an endless chain or rotational member. As the cylinders point downward the weighted piston slides to the bottom of the cylinder expelling air through the hose which flows into its mated cylinder pointing upward whose sliding piston drops thereby filling the cylinder with the same air. This process is supposed to repeat itself as the paired cylinders rotate in a fluid medium. Once again, Diamond is flawed in that it purports to “vary weights of the cylinders from less than the weight of the displaced fluid to more than the weight of the displaced fluid whereby the cylinders may selectively rise and fall within the fluid medium”. Again, injecting water or air into the cylinders, when immersed in a fluid medium will not change the “weight” or mass of the cylinders causing them to rise or fall. There is not explanation for the overall density of the cylinders. If, for example, they were made of Styrofoam, they would never sink no matter how much like fluid were injected into them. Conversely, if made of iron they would hardly rise without a huge volume of injected gas.

The rotational gravity/buoyancy power generator, in any embodiment or configuration, is superior to Diamond since it allows the containers to change their density offering a more efficient use of energy for that purpose and producing a greater net amount of useable energy.

U.S. Pat. No. 4,054,031 to Johnson calls for collapsible buckets mounted on a vertical belt on rotating shafts mounted in a tank of water. The buckets are inflated with air at the beginning of their ascent and collapse against the belt during their descent. This model may actually produce some amount of energy. However, Johnson only seeks to capture energy produced by the buoyant force and does not utilize more than 50% of its cycle when merely routing the collapsible buckets through the descent to make them available for inflation and utilization during their ascent.

U.S. Pat. No. 4,363,212 to Everett is somewhat similar to Diamond in that any potential energy it produces is a result of the buoyant force derived from air injected into a series of buckets rotating between two vertically aligned sets of chains, sprockets and shafts in a liquid. While Everett may improve on similar models it only focuses on capturing energy produced during the buoyant phase. Its buckets descend either “filled with water” or by collapsing. Thus, the energy produced in the ascending phase is partially used to move the apparatus through the descending phase.

In Everett and Johnson above, the models are less than 50% efficient since they purposely harvest energy only in the ascent phase of their operations. The present invention, in any embodiment or configuration, is at least twice as efficient since the containers and their sinking mass are used to create energy in their descent and, with their lessened density in their ascent, capitalize on the buoyant force acting thereon.

U.S. Pat. No. 2006/0288698 A1 to Dentler illustrates another notion set forth in numerous other models; that being a liquid filled tank with a rotating means which move buoyant bodies up through the tank, out of the liquid, through a descent phase in a non-liquid medium, then reintroducing the bodies into the lower portion of the liquid tank, in a repetitious cycle. Dentler and similar configurations are inferior in that these models utilize varying methods to reintroduce chain-linked, buoyant bodies into the lower portion of a liquid filled tank. In the end they all produce energy robbing friction, slow the rotation of the apparatus and introduce engineering, manufacturing and operational complications which are not found in the present invention.

### OBJECTIVES AND ADVANTAGES OF THE INVENTION

It is an object of the rotational gravity/buoyancy power generator to provide an efficient, environmentally friendly power generator.

It is another object of the rotational gravity/buoyancy power generator to provide an apparatus to generate power without consuming non-renewable resources and which does not generate pollution.

It is another object of the rotational gravity/buoyancy power generator to provide an apparatus of this character which can be located in almost any location on earth and operate at any time of day or night for generating power and thereby greatly increasing its potential use and application.

It is a further object of the rotational gravity/buoyancy power generator to provide an apparatus of this character that is relatively inexpensive to manufacture and maintain.

The characteristics and advantages of the rotational gravity/buoyancy power generator as well as methods, systems and devices for effective utilization and effectiveness thereon, are further sufficiently referred to in the detailed description of the accompanying drawings, which represent several embodiments and are incorporated herein by reference.

After considering this example, persons skilled in the art will understand that many variations may be made without departing from the principles disclosed and I contemplate the employment of any such structure, arrangements or modes of operation that are properly within the scope of the appended claims.

### SUMMARY OF THE INVENTION

The rotational gravity/buoyancy power generator apparatus harnesses the gravitational and buoyant forces which act on the apparatus, wholly or partially submersed in a natural or man-made liquid medium, and converts such forces into mechanical energy. The rotational gravity/buoyancy power generator apparatus has a plurality of weighted containers with a movable closure means on one or both ends attached to one or more chains, belts or conveyances with rotating sprockets or pulleys and horizontally aligned shafts which form a continuous loop in primarily a vertical arrangement comprising ascending and descending phases upon such apparatus in a continuous, rotating movement. Upon their sinking or descent phase the containers are open through their vertical axis allowing them to descend freely and efficiently through the liquid medium as a result of the containers being denser than the liquid they displace allowing gravity to act on the containers. Upon their rising or ascent phase a moveable closure means that is capable of an air tight seal closes the upper end or both ends of the container or a bladder is inflated as the apparatus introduces a gas directed into containers. The trapped gas filled containers increase in overall volume resulting in them having a lesser density than the liquid displaced and produce a resulting rise or ascent in the containers due to the buoyant force. The chains, belts or conveyances to which the containers are attached rotate the sprockets or pulleys and their associated shafts creating mechanical power.

Accordingly several of the objects and advantages of the invention are to provide a means to harness an alternative energy source which is environmentally friendly, can operate without dependence on wind or rivers or the sun, has a reasonably constant, non-fluctuating power output, and is simple in construction and easily maintained. Still other objects and advantages will become apparent from a study of the following description and the accompanying drawings.

### BRIEF DESCRIPTION OF THE DRAWINGS

FIG. 1A is a perspective view of the rotational gravity/buoyancy power generator apparatus with a single pair of sprockets or pulleys on two shafts driving a single chain or belt and which has attached a series of single containers. The containers are shown with a movable closure means in the form of a highly buoyant flapper valve mechanism on one end and a gas discharge means located near the lower sprocket or pulley.

FIG. 2 is an enlarged view of one container in the sinking or descent phase with the highly buoyant flapper valve in the open position. A hinge or pivot is visible as is a gas catchment device which is located on the underside of said valve. The chain or pulley is shown as is a bracket attaching the container. Liquid is shown passing through the container.

FIG. 2A is an enlarged view of one container with the movable closure means in the open position. The hinge or pivot is visible as is the motion for the movable closure means showing its travel between the open and closed positions. The gas catchment device in FIG. 2 may also be employed on the movable closure means.

FIG. 3 is an enlarged view of one container in the rising or ascent phase with the highly buoyant flapper valve closing the upper end of the container. The trapped gas and hinge or pivot are visible in the cutaway view. The chain or pulley is shown as is the bracket attaching the container.

FIG. 4 is a perspective view of the rotational gravity/buoyancy power generator apparatus with multiple pairs of sprockets or pulleys on two shafts driving a multiple chain or belt configuration and which has attached a series of sets of containers. The containers are shown with the highly buoyant flapper valve mechanism on one end and a gas discharge means located near the lower sprocket or pulley. A bracket attaching the container sets is shown.

FIG. 5 is an enlarged view of one container in the rising or ascent phase with a cutaway so that an inflated bladder is visible within. A bladder containment cover and a bladder retractor are also visible.

FIG. 6 is an enlarged view of one container in the sinking or descent phase with a cutaway so that the deflated bladder is visible within. The bladder containment cover and the bladder retractor are also visible.

FIG. 7 is a fragmentary view of one container, in partial view, in the sinking or descent phase with details for its attached, highly buoyant flapper valve and hinge or pivot in the open position. A highly buoyant flapper valve air chamber is exposed.

FIG. 8 is a fragmentary view of one container, in partial view, in the rising or ascent phase with details for its attached, highly buoyant flapper valve and hinge or pivot in the closed position. The highly buoyant flapper valve air chamber is exposed.

FIG. 9 is a partial view with the lower shaft with a longitudinal gas port, a gas inlet passage in the lower sprocket or pulley and a gas port in the bracket attaching the containers to the chain or belt—collectively referred to here as a gas injection system. The descending container on the left has its flapper valve open and has yet the engage the gas injection system. The lowest container is finishing its passage around the lower sprocket or pulley and is engaged with the gas injection system. Gas is shown passing from the axle, through the sprocket or pulley's gas inlet, through a bracket's built in gas port and into the container where the flapper valve is almost into its closed position in the upper end of the container. This gas injection system can also be utilized near the upper sprocket or pulley in a relative mirror image of that portrayed in this description for the purposes of depleting gas from the containers. Further, the gas injection system at either or both upper and lower sprockets or pulleys can be utilized for the bladders described herein such that the bladders are inflated and deflated efficiently and at the appropriate times.

### DESCRIPTION OF THE PREFERRED EMBODIMENT

The rotational gravity/buoyancy power generator apparatus is presented in two embodiments though these should not be construed as limitations on the scope of the invention but, rather, the exemplification of several preferred embodiments thereof.

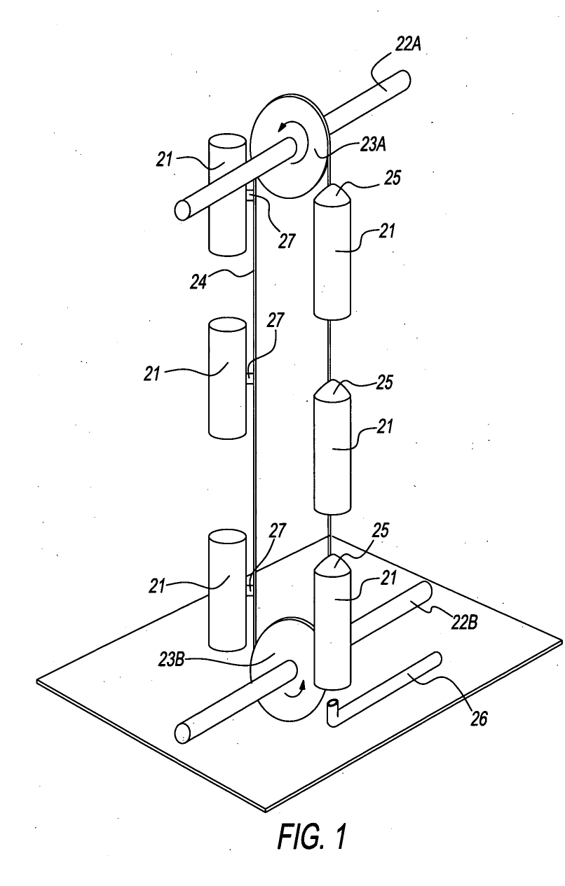

FIG. 1A shows the most basic, preferred, embodiment for the rotational gravity/buoyancy power generator. In operation the containers (21)—as they ascend and descend through the liquid medium—are attached by brackets (27) to and drive the chain or belt (24) which rotates sprockets or pulleys (23A and 23B). As the container rounds the lower sprocket or pulley (23B) the movable closure means (44) or highly buoyant flapper valve (25) seals what becomes the upper end of the container (FIG. 3). Said closure means or highly buoyant flapper valve may be fitted on its underside with a gas catchment device (26) such that the gas discharge collects primarily in said catchment device to further aid in the air tight sealing capacity of the closure means. The use of a highly buoyant flapper valve (25) aids in the ascent and descent phases of the apparatus. In the ascent it tries to rise back to the surface of the liquid medium thus sealing the container's upper end. In the descent it moves out of its seal for the same reason. A gas is introduced into the container through the gas discharge means (26). The introduction of gas into the container has several consequences: it aids the flapper valve into place, the buoyant pressure of the gas helps hold the flapper valve in place (FIG. 3), and it displaces liquid from the container. During the ascent the container, closure means and gas results in a greater overall volume of space occupied relative to its mass. The displaced liquid has a greater density than the gas filled container and the buoyant force pushes the container towards the surface.

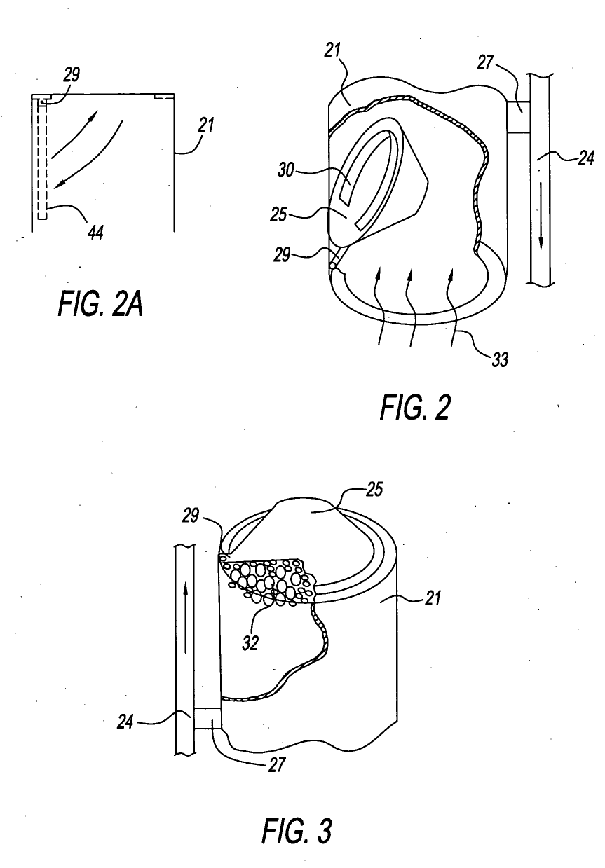

At the top of the apparatus the container rounds the upper sprocket or pulley (23A), releases its trapped gas and begins its descent. The movable closure means (44) or highly buoyant flapper valve (25) acting as one type of movable closure means moves from the downward facing opening in the container allowing the liquid (33) to pass through the container (FIG. 2) as the container sinks through the liquid medium due to the force of gravity. During descent the volume of the container is limited to its actual wall thickness and the volume of the closure means.

A different gas discharge means, as illustrated in FIG. 9, may be utilized to introduce gas into the container through an axle with a longitudinal gas port, a bracket with a gas port and a matching sprocket or pulley with its own gas ports. In this manner gas is injected at the precise moment most advantageous to the passing of the containers.

The source of gas used may include, but is not limited to, a readily available electric gas pump with its own power means, a gas pump driven by the apparatus, a gas source from industrial application such as waste gas or pressurized air and natural sources such as ocean gas vents.

The movable closure means claimed for this invention can be configured in a variety of ways. Two examples or illustrated herein—the closure means in FIG. 2A (44) and the highly buoyant flapper valve illustrated in FIG. 2 (25). However the configurations could include, but are not limited to, a bivalve from opposing sides, a bivalve from a center post, a roll-up closure, an iris closure and the location of such at either or both ends of the containers etc.; each and every one of which are contemplated herein.

As a result of this descending and ascending phases of the containers' movements a chain or belt (24) is driven which, in turn, rotates the upper and lower sprockets or pulleys (23A and 23B). This rotational energy may be utilized to drive machines or generators or for other uses.

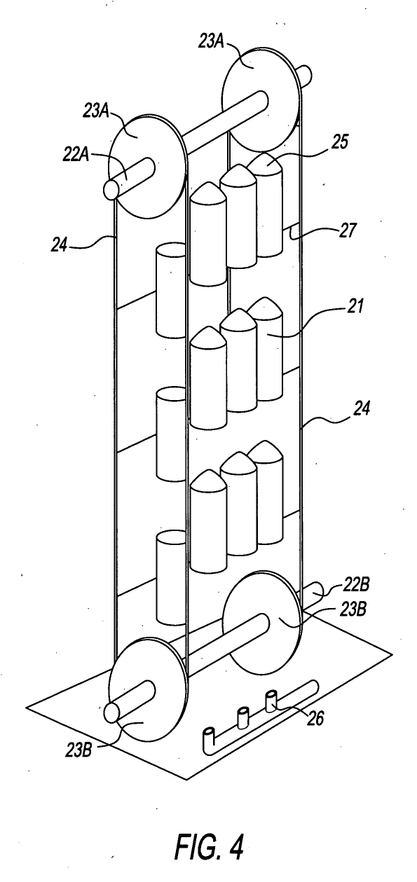

FIG. 4 shows the second illustrated, preferred embodiment. In essence, it operates in a similar fashion as the embodiment shown in FIG. 1 but it has multiple containers arranged horizontally adjacent to each other on a bracket (27) at each point along the vertically aligned chains, belts or conveyances (24). This embodiment is also shown with multiple chains or belts which are operably arranged over multiple sprockets or pulleys. One notable advantage of this embodiment is the increase in the total mass of the containers as sets and their cumulative arrangement on the rotational gravity/buoyancy power generator apparatus. The use of container sets increases the need for greater gas discharge means. This may be accomplished through the gas discharge means (26) if a movable closure means is employed or the use of the gas injection system indicated in FIG. 9 to ensure the greatest efficiency for the gas utilized.

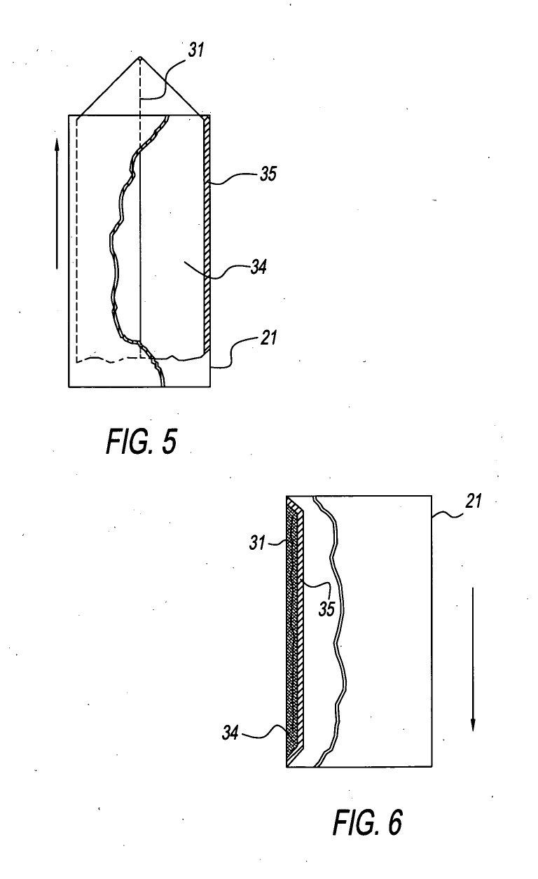

As an additional efficiency, each container may fitted internally with a collapsible gas retention device (34), hereinafter referred to as a bladder, though not limited in its design or function by this term, configured to alternatively hold and release a volume of gas, instead of the closure means (44) or highly buoyant flapper valve (25). The bladder in each container when deflated during the descending, sinking phase (FIG. 6) is held against the inside of the container allowing the liquid medium to pass through the container. The bladder may utilize a bladder containment device (35) that allows the bladder to deflate completely and be held in a relatively fixed manner against the interior wall of the container and, when inflated, conform to and maintain position with the opposite interior wall of the container. The bladder may utilize a bladder retractor (31) with elastic properties that aids in aligning the bladder inside the bladder containment device to reduce friction and aid in alignment of the bladder. Upon beginning or during its ascent the bladder is inflated so that it occupies the internal volume of the container to some degree (FIG. 5) The bladders are alternatively inflated as they pass the lower sprockets or pulleys (23B) and deflated as the pass the upper sprockets or pulleys (23A). Alternatively the apparatus may employ a cam means which aligns itself to the passing container but otherwise is mounted to the frame of or proximate to the apparatus (not shown). Said cam means or the gas injection system (FIG. 9) can be easily adapted to operate near the lower sprocket or pulley to inflate the bladders and near the upper sprocket of pulley to deflate the bladders.

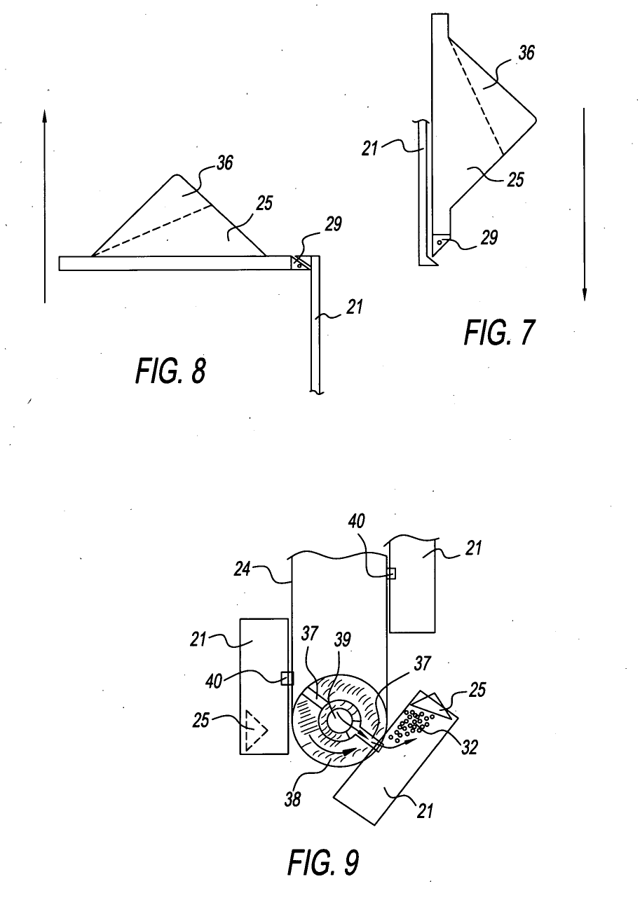

FIG. 7 and FIG. 8 show the highly buoyant flapper valve (25) in greater detail and illustrate a flapper valve air chamber (36) which is situated off center to aid the valve to align itself as quickly as possible on its pivot or hinge (29) with the container (21) in the ascent and descent.

The containers in either embodiment may be configured on their outer surface with water flow devices to aid in the containers' stability as they move through the liquid medium.

The rotational gravity/buoyancy power generating apparatus in either embodiment may utilize a flywheel on either or both shafts to assist with the smooth rotational operation.

Additionally the present invention, in any embodiment, may be used in industrial facilities where a quantity of gas is produced as a waste or by-product. The facility may be adapted to capture this gas and route such for use as the gas source for rotational gravity/buoyancy power generator.

What is claimed is:

1. A rotational gravity/buoyancy power generating apparatus for converting the potential energy of gravity and buoyancy acting on an apparatus within a liquid medium into rotational mechanical energy comprising:
a. the apparatus is immersed wholly or partly in a liquid medium such as a tank, container, man made or natural body of water;
b. one or more rotatable shafts spaced vertically apart;
c. fixed means for supporting the shafts in vertical alignment with each other, an upper shaft being relatively located above the other lower shaft;
d. said shafts are fitted with one or more sprockets or pulleys which rotate said shaft or shafts;
e. one or more endless chains, belts or conveyances disposed on the sprockets or pulleys such that at any time a portion of said chain or belt moves vertically upwardly or ascending and an opposite portion of the chain or belt moves primarily vertically downwardly or descending;
f. a plurality of containers attached to the chains, belts or conveyances and spaced apart longitudinally thereon;
g. said containers are designed to have both ends mainly open on their longitudinal axis so that liquid or gas can pass through the containers;
h. one or both ends of each container is fitted with a closure means that is capable of an air tight seal when in the closed position so that the closure means closes the upper end of the vertically aligned container when the chains, belts or conveyances are in the ascending phase. Said closure means moves freely so that when the chains, belts or conveyances are in the descending phase said closure means moves and no longer closes the end of the container thus allowing liquid or gas to pass freely through the container; and
i. A gas discharge means for discharging gas into the containers.
Whereby when gas is introduced into the containers sealed by the closure means at their ascent they have an overall lesser density than the liquid displaced and they rise through the liquid medium due to buoyant force, they release their gas at the top of the apparatus as their closure means swing open and they have an overall lesser density than the liquid displaced and they descend freely in the liquid medium due to gravity and this continuing process thereby transmits vertical motive force to the chains, belts or conveyances that is transmitted to the rotating shaft of the apparatus which rotational power can be used for mechanical purposes.

2. A rotational gravity/buoyancy power generating apparatus as defined by claim 1, wherein the closure means fitted to one or both ends of the containers is a purposely designed highly buoyant flapper valve. The highly buoyant flapper valve thus designed is assisted into the open position when the containers descend and to its sealed, closed position when the containers ascend. The highly buoyant flapper valve may be fitted on its underside with a gas catchment device such that the gas discharge collects in said catchment device to further aid in the air tight sealing capacity of the closure means.

3. A rotational gravity/buoyancy power generating apparatus as defined by claim 1, wherein there are multiple chains, belts or conveyances and multiple sprockets or pulleys on the shafts thus aiding in the stability of the containers' motion on the apparatus.

4. A rotational gravity/buoyancy power generating apparatus as defined by claim 1, wherein there are multiple container sets attached to the chain or belt and spaced apart longitudinally thereon such that said multiple containers are aligned approximately horizontally relative to each other thus increasing the capacity of the apparatus and its scalability to serve large installations.

5. A rotational gravity/buoyancy power generating apparatus as defined by claim 1 or claim 4, wherein each container is fitted with an attached collapsible gas retention device, hereinafter referred to as a bladder, though not limited in its design or function by this term, configured to alternatively hold and release a volume of gas. The bladder replaces the closure means set forth in claim 1 or the flapper valve set forth in claim 2. Said bladder inflates in or at the container at or near the beginning of the ascent to increase the displacement characteristics so that the combined volume of the container, bladder and contained gas has a lesser overall density than the liquid displaced to provide buoyancy and the container ascends. At or near the beginning of the descent the bladder deflates against the interior wall of the container or at the container so that the container is denser that the liquid displaced and the whole is acted on by gravity and the container descends. Said bladder maybe designed with a containment structure which allows the bladder to deflate completely and be held in a relatively fixed manner against the container and, when inflated, conform to and maintain position with the container. Said bladder may employ a bladder retractor with elastic properties that aids in alignment of the bladder.

6. A rotational gravity/buoyancy power generating apparatus in accordance with claim 1 or claim 5 wherein each container includes a valve means coupled to an opening in the container, such valve means being adapted to engage a cam means mounted to or proximate to said frame adjacent to said lower sprocket or pulley for reciprocal movement relative to the opening whereby when said valve engages the cam the gas can pass through the opening and into the container. An additional valve means may be adapted to engage a cam means mounted to or proximate to said frame adjacent to said upper sprocket or pulley for reciprocal movement relative to the opening whereby when said valve engages the cam gas can pass through the opening from the container. The valve means in any configuration will aid in the precision gas flow of the apparatus.

7. A rotational gravity/buoyancy power generating apparatus as defined by claim 1 or 5, containing a gas injection system wherein said upper and lower shaft contain a longitudinal passage or bore along their center which extends through said shaft to a port means located in alignment with said sprocket or pulley or otherwise to align with the containers. The port or ports align themselves at predetermined times during their rotation and in coordination with the passing containers, adapted to provide a passage from the ports, that allow for gas to pass from or into the shaft's longitudinal passage through the port and into or from the container. Said port or passage located on the shaft may be aligned directly with the appropriately adapted sprockets or pulleys and container bracket or may have a different means for engaging with the containers. The bladder in any configuration will aid in the precision gas flow of the apparatus.

8. A rotational gravity/buoyancy power generating apparatus, in any embodiment contemplated herein, which is used in a facility where a quantity of gas is produced as a waste or by-product and where the facility is adapted to capture such gas to use as the gas source for the rotational gravity/buoyancy power generating apparatus.
